(19) United States
(12) Patent Application Publication
(10) Pub. No.: US 2020/0010618 A1
(43) Pub. Date: Jan. 9, 2020

(54) A PROCESS FOR PURIFICATION OF POLYETHER BLOCK COPOLYMERS

(71) Applicant: BASF SE, Ludwigshafen (DE)

(72) Inventors: Hartwig Voss, Frankenthal (DE); Felicitas Guth, Ludwigshafen (DE); Emiel Jan Kappert, Ludwigshafen (DE); Pedro Sa Gomes, Ludwigshafen (DE)

(21) Appl. No.: 16/481,566

(22) PCT Filed: Jan. 30, 2018
(86) PCT No.: PCT/EP2018/052257

§ 371 Date: Jul. 29, 2019

(30) Foreign Application Priority Data
Feb. 9, 2017 (EP) 17155457.9

(51) Int. Cl. C08G 65/30; B01D 61/14; B01D 15/34; B01D 15/18

(52) U.S. Cl. CPC C08G 65/30; B01D 61/145; B01D 15/34; B01D 15/1857; B01D 2311/04; C08G 2650/58; B01D 2311/18; B01D 2311/25; B01D 2311/263; B01D 2325/20; B01D 2311/12

(57) ABSTRACT

Process for providing purified polyether block copolymers comprising polyoxyethylene (PEO) and polyoxypropylene (PPO) moieties wherein the purified product is obtained by an ultrafiltration step of a solution of the polyether block copolymers and wherein the block copolymers are depleted in lower molecular impurities.

This invention relates to a process for purification of polyether block copolymers comprising polyoxyethylene and polyoxypropylene moieties using ultrafiltration.

### BACKGROUND AND PRIOR ART

Poloxamers (ethylene oxide/propylene oxide triblock copolymers) have a long history of use in pharmaceutical applications. Depending on their molecular weight and ratio of ethylene oxide to propylene oxide, the polymers are used for their gel forming or solubilizing properties as excipients in topical, oral or parenteral applications.

Since many years, the use of a purified poloxamer 188 as active ingredient for the treatment of sickle cell anaemia has been described. Low molecular weight (LMW) impurities were associated with a certain renal toxicity and several methods are published dealing with their removal. U.S. Pat. No. 5,990,241 mentions gel chromatography as the method of choice for removal of impurities.

Poloxamer 188 is also used as shear protectant in suspension cell cultures in the manufacture of monoclonal antibodies. Such mammalian cells are very sensitive against variation of poloxamer quality. The root cause for failure of certain batches is not yet fully understood, but it is the hypothesis that a purified polymer with reduced levels of impurities will show an improved performance.

A purified poloxamer is used in an approved medicinal product as endovascular occlusion gel. For this application, low molecular weight impurities are removed by extraction in order to shift the gel point of the thermos-responsive poloxamer towards body temperature as disclosed for instance by U.S. Pat. No. 5,800,711 or U.S. Pat. No. 6,761,824.

Purification of poloxamers has been addressed by different techniques depending on the impurities to be removed.

According to U.S. Pat. No. 6,448,371 aldehyde impurities can be removed by treating a solution of the block copolymers with an acid.

Another method of purification is performed as a liquid extraction as mentioned in U.S. Pat. Nos. 6,761,824, 5,800,711, 5,676,1824 or 6,977,045.

According to U.S. Pat. No. 9,403,941 extraction of impurities is carried out with supercritical fluid extraction and high pressure (supercritical) methods both involving carbondioxide. These methods are shown to effectively remove undesired low and high molecular weight compounds from poloxamer 188. The disadvantage is the need of a special equipment, a complex process with at least 15 consecutive steps and the use of an organic solvent (methanol) all adding up to substantial manufacturing cost.

Other known methods are adsorption and ion exchange based methods.

Preparative batch chromatographic methods have also been addressed for the purification of poloxamers as described in U.S. Pat. No. 5,523,492. However, very diluted conditions (higher than 1500 L solvent per kg of purified product), and low productivities (below 0.1 kg treated product per kg of stationary phase per day) are associated with such techniques so that commercial application of such methods are not attractive.

As a consequence, none of these purification approaches provide a purification strategy that would allow a rather economical purification of current poloxamers grades to high purity products under reasonable product recovery, productivities rates and dilution rates.

The problem to be solved by the presently claimed invention was to provide an effective process suitable for preparative purification of poloxamers avoiding the disadvantages of the prior art. In particular, the problem of removing LMW polymer impurities, present in amounts in the range of 4-5 wt.-%, was to be solved in a cost-effective manner and with an option to abstain from organic solvents. In addition, other low molecular impurities such as aldehydes or polymeric acetals, which are present in amounts below 1 wt.-% were to be removed. Aldehydes or polymeric acetals are undesired reactive impurities in excipients, because they can impair the stability of active ingredients in a formulation.

The problem was solved by a process for providing purified polyether block copolymers comprising polyoxyethylene and polyoxypropylene moieties wherein the purified product is obtained by ultrafiltration of an aqueous solution of the polyether block copolymers.

According to the claimed invention polyether block copolymers comprising polyoxyethylene and polyoxypropylene moieties can be polyethylene oxide-block-polypropylene oxide copolymers or polyethylene oxide-polypropylene oxide random copolymers.

Triblock (PEO-PPO-PEO)-copolymers (commercially available as poloxamer, Pluronic®, Kolliphor® P, Synperonic®) have a varying block size, ratio of the respective polyoxyethylene and polyoxypropylene moieties and molecular weight. Depending on the composition and molecular weight, poloxamers can be liquid or solid at room temperature (25° C.) and water-soluble, partially soluble in water or insoluble in water. A comprehensive overview of the various grades is included in Alexandris P. et al: Physicochem. Eng. Aspects 96 (1995) 1-46. Poloxamer is the INN-name for such block copolymers. The general formula is HO—[(CH₂)₂—O—]ₐ—[(CH₂)₃—O—]_{b}—[(CH₂)₂—O—]ₐ—H with a=2-130, b=15-67. Each poloxamer is characterized by a number. The first two digits multiplied with 100 represents the average molecular weight of the polyoxypropylene moiety and the last digit multiplied with 10 the weight percentage of the polyoxyethylene moiety. Typical examples are poloxamers 124, 188, 237, 338, 407.

Inverse poloxamers (PPO-PEO-PPO triblock copolymers also known as meroxapols) are commercially available as Pluronic® RPE.

Poloxamines and reverse poloxamines resemble the poloxamers and meroxapols in having the same sequential order of polyethylene oxide and polypropylene oxide but as they are prepared from an ethylene diamine initiator, they have four alkylene oxide chains.

Pluradot® polyethylene oxide-polypropylene oxide block copolymers are initiated with a trifunctional initiator and therefore have three chains.

Other polyether block copolymers subject to this invention are block and random copolymers composed of polyethylene oxide and polybutylene oxide, they can be PEO-PBO-PBO diblock copolymers or PEO-PBO-PEO triblock copolymers, also known as Butronics®.

A systematic overview on the above mentioned block polymers is presented by Schmolka, I., Journal of the American Oil Chemists' Society, Vol 54 (3) 1977.

Preferred polyether block copolymers are tri-block copolymers with a molecular weight ranging from 0.5 kD to about 50 kD, preferably from 1 kD to about 25 kD, particularly Poloxamer P188 and P407, kD meaning “kiloDalton”.

To purify the block polymers by ultrafiltration, i.e. to remove low molecular compounds dissolved in the aqueous solution, the aqueous solution is brought into contact with a membrane under pressure, and the permeate free of the target block copolymers (filtrate) comprising the dissolved impurities is drawn off on the reverse side of the membrane at a lower pressure than on the feed side.

The cut-off for low molecular weight compounds in polyether block copolymers that can be removed by ultrafiltration depends on the properties of the membrane and the molecular weight distribution of the target polymer. The desired cut-off for poloxamer 188 are low molecular weight compounds below 5 kD and the desired cut-off for poloxamer 407 are low molecular weight compounds below 10 kD.

Water is the preferred solvent, but the ultrafiltration can also be performed with organic solvents or solvent/water mixtures. Suitable organic solvents are: Methanol, ethanol, acetonitril, acetone, ethyl acetate, polyethylene glycol 300 and 400, dimethyl formamide, isopropanol, propylene glycol toluene, tetrahydrofurane.

Preferred organic solvents are: Methanol, ethanol, acetonitril, acetone, ethyl acetate

Suitable concentrations of the polymer in the solvent are 0.1-50% b.w., preferably 2-20% b.w. and most preferably 5-15% b.w.

A polymer solution which is depleted in low molecular weight impurities is obtained as retentate. To prevent the block copolymer concentration becoming too high, the removed amount of permeate can be continuously or discontinuously replaced in the retentate by the solvent used for the process.

An ultrafiltration in which the polymer solution is not concentrated, but in which the removed amount of permeate is replaced by the solvent water, is also referred to as diafiltration.

The diafiltration and concentration steps can take place in a batch-wise procedure in which the suspension is circulated through the membrane modules until the desired separation has been achieved, in a fed-batch mode in which the removed permeate solution is replaced by the original feed, or continuously by passing once through one or more feed-and-bleed stages connected in series.

For the membrane process it is possible to employ membrane separating layers with pore sizes in the range of 0.1 to 200 nm. Instead of the pore size, for ultrafiltration membranes membrane producers typically indicate the molecular weight cut-off of the membranes. The cut-off ranges in kD (kiloDalton) correspond to a certain extent with one to two times the pore size in nm, but can be dependent on the testing procedure used by the membrane manufacturer. The cut-offs for the present invention preferably lie in the range of 1-30 kD and most preferably in the range of 5-15 kD. The separating layers may consist of organic polymers, ceramic, carbon or combinations thereof and must be stable in the feed medium at the filtration temperature. For mechanical reasons, the separating layers are usually applied to a mono- or multi-layer porous substructure made of the same or else a plurality of different materials as the separating layer.

Examples of possible material combinations are detailed in the following table:

| Separating layer | Substructure (coarser than separating layer) |
|---|---|
| Ceramic | Metal, ceramic or carbon |
| Polymer | Polymer, metal, ceramic or ceramic on metal |
| Carbon | Carbon, metal or ceramic |

Ceramic: e.g. α-Al₂O₃, ZrO₂, TiO₂, SiC, mixed ceramic materials
Polymer: e.g. PP, PTFE, PVDF, polysulfone, polyethersulfone, polyetheretherketone, polyamide, polyacrylonitrile, regenerated cellulose

The membranes listed in the following table are non-limiting examples of suitable membranes, many more membranes are commercially available and can be chosen by the skilled artisan:

| | Cut-off (kD) |
|---|---|
| Membrane | Pore diameter (nm, μm) |
| TiO₂ or ZrO₂ on α-Al₂O₃/1, 2 | 1, 5, 10, 20 or 100 kD |
| | In the range of from: 3, nm |
| | 5 nm to 0.02 μm, 0.05 μm |
| | or 0.1 μm |
| UF/ZrO₂—TiO₂ on carbon/1 | 50 and 150 kD |
| Cellulose Acetate/1 | 2 kD |
| (modified) polyethersulfone/1 | 4, 6, 9 kD |
| polysulfone/1 | 8, 20 kD |
| PVDF/1 | 20, 100 kD |
| Modified polyethersulfone/3 | 10, 30, 100 kD |
| Fluoropolymer on PP/3 | 1, 10 kD |
| Regenerated cellulose on PP/3 | 10 kD |
| Polysulfone or polyethersulfone on | 2, 5, 10, 20, 25, 50 kD |
| polyester/3 | |
| Polyethersulfone/1 or | 4, 5, 10, 20, 30 or 50 kD |
| Polyethersulfone/3, optionally | |
| hydrophilized | |

1: tubular or hollow-fibre membrane; 2: multichannel element; 3: flat membrane for spiral-wound and plate-and-tray modules

Particularly preferred separating layers are composed of, for example, ceramic (Al₂O₃, ZrO₂, TiO₂), regenerated cellulose, cellulose acetate, polyacrylonitrile and hydrophilized polyacrylonitrile, polysulfone and hydrophilized polysulfone, polyethersulfone and hydrophilized polyethersulfone, polyetheretherketone and hydrophilized polyetheretherketone, and hydrophilized PVDF.

The membranes can be employed in principle in flat, spiral-wound, tubular, multi-channel element, capillary or coiled geometry, for which appropriate pressure housings which allow separation between retentate and the permeate are available.

The optimal transmembrane pressures between retentate and permeate are, substantially dependent on the diameter of the membrane pores, the hydrodynamic conditions which influence the build-up of covering layer, and the mechanical stability of the membrane at the filtration temperature, depending on the type of membrane, preferably in a range from 0.02 to 2 MPa, particularly preferably in a range from 0.03 to 0.66 MPa. Higher transmembrane pressures usually lead to higher permeate flows. It is moreover possible in the case where a plurality of modules is arranged in series for the transmembrane pressure to be lowered and thus adapted for each module by raising the permeate pressure. The operating temperature depends on the membrane stability and the thermal stability of the dispersion. A suitable temperature range for ultrafiltration is 20 to 80° C. Higher temperatures usually lead to higher permeate flows. The permeate flows which can be achieved depend greatly on the type of membrane and membrane geometry employed, on the process conditions, on the feed composition (substantially the polymer concentration). The flows for ultrafiltration are typically in a range from 5 to 500 kg/m²/h, and for polymer fractionations in specific the flows are typically in the range of 5-100 kg/m²/h. For industrial applications, a flow of at least 20 kg/m²/h is often desired.

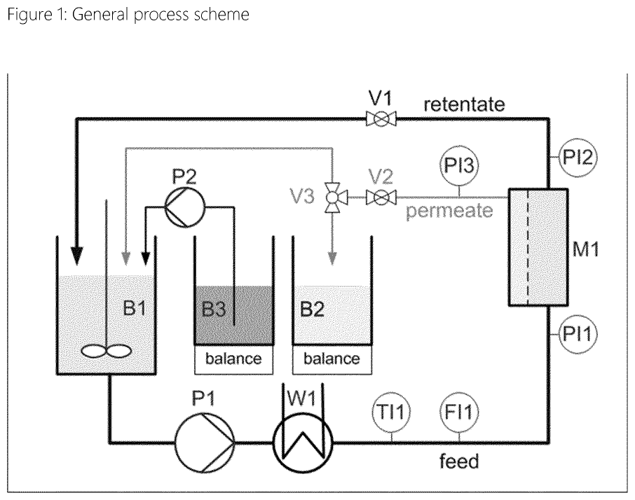

The process is further illustrated by FIG. 1:

FIG. 1 depicts a test unit with a feed/retentate circulation loop consisting of a feed/retentate circulation vessel B1, a circulation pump P1, a heat exchanger W1, a membrane module M1 and a pressure control valve V1. Between the heat exchanger W1 and the module entrance a temperature TM, a flow FM and a pressure PH and between the module outlet and the pressure control valve V1 an additional pressure P12 measurement is sited. The permeate pressure is measured by P13 and adjusted by the permeate pressure control valve V2. Via the three-way valve V3 the permeate can be led to the permeate vessel B2 or back to the circulation vessel B1 (the permeate is recycled). The permeate flux is measured by the weight increase over time in the permeate vessel B2.

Two operation modes are possible:

Concentration mode: In this case the permeate is gathered in B2 and the hold-up of the circulation loop and B1 is reduced respectively. The mass concentration factor CF is defined by CF=mret,0/mret,t=mret,0 (mret,0−mperm,t) mret,0 =initial feed mass in B1 and the circulation loop, trial time=0 mret,t=mass in B1 and the circulation loop at trial time t mperm,t=permeate mass in B2 at trial time t

Diafiltration mode: In this case the gathered permeate in B2 is balanced by the permeate medium which is fed from B3 by the pump P2. The mass diafiltration coefficient DF is defined DF=mperm,t/m0

mret,0=initial feed mass in B1 and the circulation loop, constant over trial time mret,0=mret,t

mperm,t=permeate mass in B2 at trial time t

permeate mass=diafiltration medium mass at each trial time

Further definitions:

The selectivity of the membrane is defined by the Rejection R=1−(cP/cR)

cR=concentration on the feed side of the membrane

cP=concentration on the permeate side of the membrane

The samples for the determination of both concentrations have to be taken at the same time, concentration factor or mass diafiltration coefficient.

The concentration can refer to the solid content, a specific molecule or a polymer fraction defined by the molecular weight.

The trans membrane pressure TMP is calculated from P11, P12 and P13 TMP=((P11+P12)/2)−P13

The cross flow velocity is calculated from the feed flow and area of the feed flow channel.

According to another embodiment of the invention the ultrafiltration step can be combined with an acid treatment step in order to remove impurities that are prone to hydrolysis, particularly to remove aldehyde impurities. This acid treatment is carried out prior to the ultrafiltration step or simultaneously with the ultrafiltration step. The acid treatment can be carried out in a separate apparatus or in the ultrafiltration apparatus. The acid treatment is carried out by (i) dissolving the block copolymers in a solvent, preferably water, methanol, ethanol or aqueous mixtures thereof (ii) adding one or more acids and (iii) removal of the hydrolysed impurities. According to the embodiment wherein the acid treatment is carried out simultaneously with the ultrafiltration step, the acid is added to the feed solution for the ultrafiltration. The acid added to the block copolymer solution can be any acid that is strong enough to start the hydrolytic reaction and not too corrosive. The acid can be chosen from the group of inorganic acids consisting of sulfuric acid, nitric acid, hydrochloric acid and sulfonic acid, phosphoric acid, preferably hydrochloric or sulfuric acid. The acid can also be chosen from the group of organic acids consisting of formic acid, acetic acid, propionic acid, fumaric acid, tartaric acid, butyric acid, benzoic acid, succinic acid, oxalic acid, malic acid, lactic acid, adipic acid or citric acid. Pure acids or mixtures can be used and the amount of acid depends on the desired pH value. The pH for the acid treatment can be in the range of from 1 to 5, preferably 3. The concentration of the aqueous acid used to set the pH is preferably in the range of from 0.1 to 2 mol/ L.

Treatment time depends on the amounts of impurities to be hydrolysed, but is usually not less than one hour and up to two hours. The skilled artisan will know how to adapt the required time period for a given case.

The acid treatment can be carried out at temperatures in the range of from 20 to 60° C.,

preferably 25 to 40.

The pressure for the acid treatment is chosen to lie in the range of from 0.1 to 1 MPa, preferably 0.1 to 0.5 MPa.

The reaction can be carried out under ambient atmosphere or under protective atmosphere. Suitable inert gases for the treatment are nitrogen, helium, argon, carbon dioxide.

After the ultrafiltration step which optionally combined with the acid hydrolysis step, the solution comprising the purified target block copolymer can be converted to give a powderous polymer by known processes such as heating and distilling the water off until the polymers are molten. The molten polymers can be cooled to give a solid mass which can be converted to powders by convention methods such as for instance cryo-milling. Alternatively, the molten mass can be converted to powders by spray processes.

According to another embodiment of the invention the method of purification of poloxamers by ultrafiltration is combined with a process for purification of polyether block copolymers comprising polyoxyethylene and polyoxypropylene moieties using sequential mufti-column size exclusion chromatography in a simulated moving bed apparatus.

Before the solution obtained by ultrafiltration is subjected to the size exclusion chromatography in a simulated moving bed apparatus the solution can be concentrated by removing water and subsequently be diluted with methanol.

The process for purification of polyether block copolymers comprising polyoxyethylene and polyoxypropylene moieties using sequential mufti-column size exclusion chromatography in a simulated moving bed apparatus (SMB chromatography) wherein a process cycle comprises the steps of
(i) providing a feed mixture comprising the block copolymers dissolved in an eluent in a feed vessel,
(ii) subjecting the feed mixture to a chromatographic separation by introducing the feed mixture into an apparatus comprising a plurality of chromatographic columns sequentially linked together, each column comprising a stationary phase,
(iii) after separation collecting a first eluent portion enriched in the purified target block copolymer and a second eluent portion depleted of the purified target block copolymer,
(iv) collecting the purified block copolymer from the first eluent portion, and
(v) recovery of the depleted eluent and recycling the depleted eluent into the process.

According to this embodiment impurities with a molecular weight higher than the molecular weight of the target block copolymer can be removed.

The respective equipment for carrying out the size exclusion chromatography is commercially available and can be adapted by the skilled expert to the specific needs of the separation process, operated under different pumps, valves and configuration and columns in static position or as actual moving bed (AMB, CSEP, ISEP apparatus) as described in U.S. Pat. No. 7,141,172.

The eluent can be an organic solvent or water or a mixture thereof.

According to a particularly preferred embodiment the eluent is methanol or a mixture of methanol with water or other organic solvents, particularly acetonitrile and/or acetone.

The stationary phase comprises a size exclusion chromatographic packing material. According to one preferred embodiment the stationary bed comprises as an inorganic adsorbent a silica based material, more preferably a silica diol. The silica diols are silica particles modified with 1,2-dihydroxypropane to cover the surface of the particles with diol groups. Such silica diol materials are commercially available at bulk quantities and different pore and particle sizes.

The number of columns used in each apparatus is not particularly limited. A skilled person would easily be able to determine an appropriate number of columns depending the amount of material to be purified.

The SMB separation can be operated as a high pressure process or as a low pressure process. The separation process is preferably carried out at high pressures >0.5 MPa up to an upper limit in the range of 10 MPa.

Typically, the temperature of the columns is limited from a lower level where the formation of crystals or particulates may be observed up to vaporization of solute or solvent. According to one embodiment the process is carried out at constant room temperature from 20 to 25° C. Optionally the process can be carried out at higher temperatures in the range of from 30 to 65. ° C.

After the block copolymers of the invention have been subjected to an ultrafiltration they are distinguished by very low residual contents of low molecular impurities. It is thus possible to provide block copolymers which are suitable in particular as excipients in the cell culture production of biologicals, as processing aids for other biotechnological applications such as cell engineering or as excipients in specific pharmaceutical dosage forms. In combination with a SMB chromatographic process higher molecular impurities can be removed as well so that poloxamers with a very defined molecular weight fraction can be achieved.

The successful removal of low molecular weight compounds or impuritites can be controlled by the following analytical methods:

The molecular weight distribution of poloxamers is determined by size exclusion chromatography (HPLC) The principle of this analytical technique is known to the expert.

This method is preferably carried out under the following conditions:

Stationary phase (columns): 3 columns sulfonated polystyrene/divinylbenzene resins (300×8 mm SDV 1000A/100.000A/1.000 000A)

1 analytical pre-column (sulfonated polystyrene divinylbenzene copolymer

Solvent: Tetrahydrofuran (THF)

Column temperature: 60° C.

Flow: 1 mL/min

Injection volume: 100 DL

Concentration: 2 mg/mL

Samples were filtered prior to analysis Macherey-Nagel PTFE-20/25 (0.2 Dm)

Calibration: Polyethylene glycol with narrow molar mass in the range of 106-1.522.000 g/mol)

Detector: RID Agilent 1100

However, other variations of this method will work as well and can be adapted by the skilled artisan to this specific problem.

The successful removal of impurities by acid treatment, specifically aldehyde or acetal impurities, can be controlled by the following analytical method:

The aldehydes are determined by reversed phase HPLC after reaction of the sample with 2,4-dinitrophenylhydrazine as the respective dinitrophenyl hydrazine derivatives. For quantification an external standard is applied using UV detection at 370 nm.

Sample derivatization: 60 mg of poloxamer 188 are weighted (accurate to 0.01 mg) into a 10 mL volumetric flask, dissolved in 1 mL acetonitrile, and derivatized by addition of 1-2 mL reagent solution followed by heating to 60° C. for 5 min. After cooling down to ambient temperature, the flask is filled up to the mark with acetonitrile/ water (1:1)

Reagent solution: 4 g with 2,4-dinitrophenylhydrazine (stabilized with 50% b.w. water) are weighed into a 1 L Erlenmeyer flask. 800 mL water and 200 mL concentrated hydrochloric acid are added. The mixture is stirred until it is clear.

Stationary phase: Symmetry Shield RP 18-5 μm, Waters (2.1 mm diameter, stainless steel)

Calibration solutions: 20 mg of aldehyde dinitrophenylhydrazones are weighed, accurate to 0.01 mg and dissolved in acetonitrile. Dilutions are adjusted in such a way that the concentration of hydrazine is within the ranges listed below:

Formaldehyde derivative 0.0021-0.43 mg/10 mL injection solution

Acetaldehyde derivative 0.0024-0.47 mg/10 mL injection solution

Propionic aldehyde derivative . 0.0024-0.47 mg/10 mL injection solution

Mobile phase: water (A)/acetonitrile (B) gradient:

| t/min | A [%] | B [%] |
|---|---|---|
| 0 | 60 | 40 |
| 25 | 30 | 70 |
| 35 | 30 | 70 |
| 36 | 60 | 40 |
| 45 | 60 | 40 |

Flow: 0.4 mL/min

Injection volume: 5 μL

Temperature: 45° C.

Detection: UV/VIS, lambda=370 nm

Thus, the present invention is characterized by the following specific embodiments.

### Embodiment 1

Process for providing purified polyether block copolymers comprising polyoxyethylene (PEO) and polyoxypropylene (PPO) moieties wherein the purified product is obtained by an ultrafiltration step of a solution of the polyether block copolymers.

### Embodiment 2

Process according to Embodiment 1, wherein the polyether block copolymers comprising polyoxyethylene and polyoxypropylene moieties are selected from the group consisting of polyethylene oxide- block- polypropylene oxide copolymers or polyethylene oxide-polypropylene oxide random copolymers.

### Embodiment 3

Process according to Embodiment 1 or 2, wherein the polyether block copolymers comprising polyoxyethylene and polyoxypropylene moieties are triblock (PEO-PPO-PEO)-copolymers.

### Embodiment 4

Process according to any of Embodiments 1 to 3 wherein the triblock (PEO-PPO-PEO)-copolymers are poloxamer 188 or poloxamer 407.

### Embodiment 5

Process according to any of Embodiments 1 to 4 wherein the triblock (PEO-PPO-PEO)-copolymers is poloxamer 188.

### Embodiment 6

Process according to any of Embodiments 1 to 5, wherein the solution of the polyether block copolymers treated by ultrafiltration is an aqueous solution or an organic solution or an aqueous-organic solvent mixture.

### Embodiment 7

Process according to any of Embodiments 1 to 6, wherein the solution of the polyether block copolymers treated by ultrafiltration is an aqueous solution.

### Embodiment 8

Process according to any of Embodiments 1 to 6, wherein the solution of the polyether block copolymers treated by ultrafiltration is an organic solution or an aqueous-organic solvent mixture.

### Embodiment 9

Process according to any of Embodiments 1 to 6 and 8, wherein the organic solvent is selected from the group consisting of methanol, ethanol, acetonitril, acetone, ethyl acetate.

### Embodiment 10

Process according to any of Embodiments 1 to 9, wherein the concentration of the polymer in the solution is 1-50% b.w.

### Embodiment 11

Process according to any of Embodiments 1 to 10, wherein the concentration of the polymer in the solution is 2-20% b.w.

### Embodiment 12

Process according to any of Embodiments 1 to 11, wherein the concentration of the polymer in the solution is 5-15% b.w.

### Embodiment 13

Process according to any of Embodiments 1 to 12, wherein the block polymers to be purified by ultrafiltration to remove low molecular compounds are dissolved in the aqueous solution, and the aqueous solution is brought into contact with a membrane under pressure, and the permeate free of the target block copolymers (filtrate) comprising the dissolved impurities is drawn off on the reverse side of the membrane at a lower pressure than on the feed side.

### Embodiment 14

Process according to any of Embodiments 1 to 13, wherein the ultrafiltration is carried out using a membrane separating layer which is a ceramic or polymer or carbon material.

### Embodiment 15

Process according to any of Embodiments 1 to 14, wherein the ultrafiltration is carried out using a membrane separating layer which is a ceramic material.

### Embodiment 16

Process according to any of Embodiments 1 to 15, wherein the ultrafiltration is carried out using a membrane separating layer which is a ceramic material selected from the group consisting of alpha-Al₂O₃, ZrO₂, TiO₂, SiC and/or mixed ceramic materials.

### Embodiment 17

Process according to any of Embodiments 1 to 18, wherein the ultrafiltration is carried out using a membrane separating layer which is a ceramic material with ZrO₂ layered on alpha-Al₂O₃.

### Embodiment 18

Process according to any of Embodiments 1 to 17, wherein the ultrafiltration is carried out using a membrane separating layer with a cut-off in the range of from 1 to 150 kD (kiloDalton).

### Embodiment 19

Process according to any of Embodiments 1 to 18, wherein the ultrafiltration is carried out using a membrane separating layer with a cut-off of 1, 5, 10, 20 or 100 kD (kiloDalton).

### Embodiment 20

Process according to any of Embodiments 1 to 19, wherein the ultrafiltration is carried out using a membrane separating layer with a cut-off in the range of from 1 to 50 kD (kiloDalton).

### Embodiment 21

Process according to any of Embodiments 1 to 20, wherein the ultrafiltration is carried out with a transmembrane pressure preferably in a range from 0.02 to 2 MPa, particularly preferably in a range from 0.03 to 0.66 MPa.

### Embodiment 22

Process according to any of Embodiments 1 to 21, wherein the ultrafiltration step is combined with an acid treatment step wherein the acid treatment step is carried out prior to or simultaneously with the ultrafiltration step.

### Embodiment 23

Process according to any of Embodiments 1 to 22, wherein the acid treatment step is carried out in a solution of the polyether block copolymer in water or an organic solvent or aqueous-organic solvent mixtures.

### Embodiment 24

Process according to any of Embodiments 1 to 23, wherein the acid treatment is carried out at a pH in the range of from pH 1 to pH 5.

### Embodiment 25

Process according to any of Embodiments 1 to 24, wherein the acid treatment is carried out at a pH in the range of pH 3.

### Embodiment 26

Process according to any of Embodiments 1 to 25, wherein the acid is selected from the group of inorganic acids consisting of sulfuric acid, nitric acid, hydrochloric acid, sulfonic acid and phosphoric acid.

### Embodiment 27

Process according to any of Embodiments 1 to 26, wherein the acid is hydrochloric or sulfuric acid.

### Embodiment 28

Process according to any of Embodiments 1 to 27, wherein the acid is sulfuric acid.

### Embodiment 29

Process according to any of Embodiments 1 to 25, wherein the acid is selected from the group of organic acids consisting of formic acid, acetic acid, propionic acid, fumaric acid, tartaric acid, butyric acid, benzoic acid, succinic acid, oxalic acid, malic acid, lactic acid, adipic acid or citric acid.

### Embodiment 30

Process according to any of Embodiments 1 to 29, wherein the concentration of the aqueous acid used to set the pH is preferably in the range of from 0.1 to 2 mol/ L.

### Embodiment 31

Process according to any of Embodiments 1 to 30 wherein the acid treatment is carried out at temperatures in the range of from 20 to 60° C.

### Embodiment 32

Process according to any of Embodiments 1 to 31, wherein the acid treatment is carried out at temperatures in the range of from 25 to 40° C.

### Embodiment 33

Process according to any of Embodiments 1 to 32, wherein the pressure for the acid treatment is chosen to lie in the range of from 0.1 to 1 MPa, preferably 0.1 to 0.5 MPa.

### Embodiment 34

Process according to any of Embodiments 1 to 33, wherein the purified product obtained by the ultrafiltration step is further subjected to sequential mufti-column size exclusion chromatography in a simulated moving bed apparatus.

### Embodiment 35

Process according to Embodiment 34, wherein a process cycle comprises the steps of providing a feed mixture comprising the block copolymers dissolved in an eluent in a feed vessel, subjecting the feed mixture to a chromatographic separation by introducing the feed mixture into an apparatus comprising a plurality of chromatographic columns sequentially linked together, each column comprising a stationary phase, after separation collecting a first eluent portion enriched in the purified target block copolymer and a second eluent portion depleted of the purified target block copolymer, collecting the purified block copolymer from the first eluent portion, and recovery of the depleted eluent and recycling the depleted eluent into the process.

### Embodiment 36

Process according to any of embodiments 1 to 36, wherein the removal of low molecular weight compounds is determined by size exclusion chromatography. The method which can be applied for all embodiments is described in detail above.

### Embodiment 37

Process according to any of embodiments 1 to 37, wherein the removal of impurities by acid treatment is be controlled by the following analytical method:

the aldehydes are determined by reversed phase HPLC after reaction of the sample with 2,4-dinitrophenylhydrazine as the respective dinitrophenyl hydrazones. For quantification an external standard is applied using UV detection at 370 nm. The method is described in detail above.

### Embodiment 38

Process according to any of Embodiments 1 to 37, wherein a low molecular impurity is an impurity with a molecular weight below the average molecular weight of the target polyether block polymer to be purified.

### Embodiment 39

Process according to any of Embodiments 1 to 38, wherein a low molecular impurity is an impurity with an average molecular weight at least 1500 g/mol below the average molecular weight of the target polyether block polymer to be purified.

### Embodiment 40

Process according to any of Embodiments 1 to 38, wherein a low molecular impurity is an impurity with an average molecular weight at least 2000 g/mol below the average molecular weight of the target polyether block polymer to be purified and wherein the impurity is a polyether polymer.

### Embodiment 41

Process according to any of Embodiments 1 to 38, wherein a low molecular impurity is an impurity with an average molecular weight at least 3000 g/mol below the average molecular weight of the target polyether block polymer to be purified and wherein the impurity is a polyether polymer

### Embodiment 42

Process according to any of Embodiments 1 to 40, wherein a low molecular impurity is an impurity carrying aldehyde or acetal groups.

The following examples further describe the invention without limiting its scope.

### EXAMPLES

In the following examples “%”, if not further specified. means “% by weight”

All ultrafiltration experiments in the following examples were carried out using a membrane with zircon dioxide layered on alpha-Al₂O₃.

The molecular weight distribution of poloxamers was determined by size exclusion chromatography (HPLC) under the followings conditions:

Stationary phase (columns): 3 columns sulfonated polystyrene/divinylbenzene resins (300×8 mm SDV 1000A/100.000A/1.000 000A)

1 analytical pre-column (sulfonated polystyrene divinylbenzene copolymer

Solvent: Tetrahydrofuran (THF)

Column temperature: 60° C.

Flow:1 mL/min

Injection volume: 100 DL

Concentration: 2 mg/mL

Samples were filtered prior to analysis Macherey-Nagel PTFE-20/25 (0.2 Dm)

Calibration: Polyethylene glycol with narrow molar mass in the range of 106-1.522.000 g/mol)

Detector: RID Agilent 1100

The aldehydes were determined by reversed phase HPLC after reaction of the sample with 2,4-dinitrophenylhydrazine as the respective dinitrophenyl hydrazones. For quantification an external standard was applied using UV detection at 370 nm.

Sample derivatization: 60 mg of poloxamer 188 were weighed (accurate to 0.01 mg) into a 10 mL volumetric flask, dissolved in 1 mL acetonitrile, and derivatized by addition of 1-2 mL reagent solution followed by heating to 60° C. for 5 min. After cooling down to ambient temperature, the flask is filled up to the mark with acetonitrile/water (1:1)

Reagent solution: Approx. 4 g with 2,4-dinitrophenylhydrazine (stabilized with 50% water) re weighed into a 1 L Erlenmeyer flask. 800 mL water and 200 mL concentrated hydrochloric acid were added. The mixture is stirred until it is clear.

Stationary phase: Symmetry Shield RP 18-5 μm, Waters (2.1 mm diameter, stainless steel)

Calibration solutions: 20 mg of aldehyde dinitrophenylhydrazones were weighed, accurate to 0.01 mg, and dissolved in acetonitrile. Dilutions were adjusted in such a way that the concentration of hydrazine is within the following ranges:

Formaldehyde derivative 0.0021-0.43 mg/10 mL injection solution

Acetaldehyde derivative 0.0024-0.47 mg/10 mL injection solution

Propionic aldehyde derivative Approx. 0.0024-0.47 mg/10 mL injection solution

Mobile phase: water (A)/acetonitrile (B) gradient:

| t/min | A [%] | B [%] |
|---|---|---|
| 0 | 60 | 40 |
| 25 | 30 | 70 |
| 35 | 30 | 70 |
| 36 | 60 | 40 |
| 45 | 60 | 40 |

Flow: 0.4 mL/min

Injection volume: 5 μL

Temperature: 45° C.

Detection: UV/VIS, lambda=370 nm

The total aldehyde contents listed in the tables for the starting materials are calculated on the basis of the hydrazone derivatives (comprising hydrazine derivatives of free aldehydes and the acetals, which are trapped in the polymer and are released after hydrolysis).

### Example 1

The first experiment was performed using a 100 mm long 10/6 UF5 kDZ membrane (atech innovations Gmbh). The circulation vessel B1 was filled with 2829 g Poloxamer 188 solution, having a solid content of 10.26%. The experimental conditions were set to obtain a temperature of 60° C., a cross-flow velocity of 4 m/s and a trans-membrane pressure of 0.1MPa. Table 1 summarizes the results of this experiment. First, the experiment was run in a diafiltration mode until a diafiltration factor DF of 3.91 was reached. During this step, the solid contents in the retentate dropped from 10.26 to 6.66%. Because of the decreased polymer content in the retentate, an increase in the membrane flux was recorded. Subsequently, the polymer was concentrated by a factor 2 to a retentate concentration of 12.74% as shown in Table 2.

TABLE 1

| DF | Flux | C_{Ret} | C_{Perm} | R |
|---|---|---|---|---|
| — | kg/m²/h | % | % | — |
| 0.00 | 22.4 | 10.26 | 1.34 | 86.9 |
| 0.48 | 25.4 | 9.75 | 1.05 | 89.2 |
| 0.96 | 29.6 | 9.04 | 0.75 | 91.7 |
| 2.05 | 37.3 | 7.88 | 0.59 | 92.5 |
| 2.91 | 42.3 | 7.30 | 0.48 | 93.5 |
| 3.91 | 47.6 | 6.66 | 0.38 | 94.3 |

TABLE 2

| CF | Flux | C_{Ret} | C_{Perm} | R |
|---|---|---|---|---|
| — | kg/m²/h | % | % | — |
| 1.00 | 47.6 | 6.66 | 0.38 | 94.3 |
| 1.20 | 36.5 | | | |
| 1.40 | 27.9 | | | |
| 1.60 | 20.3 | | | |
| 1.80 | 14.5 | | | |
| 2.04 | 10.0 | 12.74 | 0.97 | 92.4 |

Results obtained by size exclusion chromatography according to Table 3 show that low molecular weight compounds can be removed effectively from a standard commercial grade Poloxamer 188:

TABLE 3

| | | | | | Area |
|---|---|---|---|---|---|
| | Mn | Mw | D | Area % < 5000 | % > 13000 |
| Sample | [g/mol] | [g/mol] | [Mn/Mw] | g/mol | g/mol |
| Starting | 7330 | 7870 | 1.07 | 5.99 | 1.04 |
| material | | | | | |
| Example | 7900 | 8140 | 1.03 | 1.22 | 1.25 |
| #1 | | | | | |

Total aldehyde levels obtained by using the HPLC method described above are summarized in the following Table 4:

TABLE 4

| | Formaldehyde | Acetaldehyde | Propionic aldehyde |
|---|---|---|---|
| Sample | [ppm] | [ppm] | [ppm] |
| Starting material | <10 | 163 | 257 |
| Example #1 | <10 | 87 | 29 |

The results show that aldehydes levels were significantly reduced by the acid treatment in comparison to the levels of the starting material.

### Example 2

The second experiment was performed using a 100 mm long 10/6 UF5kDZ membrane (atech innovations gmbh). The circulation vessel B1 was filled with 3185 gram Poloxamer 188 solution, having a solids content of 10.44%. Prior to starting the filtration, the Poloxamer was recycled in the setup under permeate recycle into the feed vessel at 30° C. The pH was set to 3 using 1.81 g 10% H₂SO₄. Directly after setting the pH, the temperature was increased to 60° C. and the mixture was recirculated for 2h. Dosing of the acid did not result in a change in solid contents. Subsequently, the mixture was diafiltrated at 60° C., a cross-flow velocity of 4 m/s and a trans-membrane pressure of 0.1 MPa until a diafiltration factor of 3.76 was reached. Table 5 summarizes the results of this experiment. During this step, the solid contents dropped from 10.46% to 6.23%. Because of the decreased polymer content in the retentate, an increase in the membrane flux was recorded. The flux behavior was similar to that obtained in Example 1.

TABLE 5

| DF | Flux | C_{Ret} | C_{Perm} | R |
|---|---|---|---|---|
| — | kg/m²/h | % | % | — |
| 0.00 | 22.4 | 10.46 | 1.42 | 86.4 |
| 0.95 | 25.4 | 9.06 | 0.78 | 91.4 |
| 1.89 | 29.6 | 8.28 | 0.63 | 92.4 |
| 2.83 | 37.3 | 7.74 | 0.51 | 93.4 |
| 3.76 | 42.3 | 6.23 | 0.38 | 93.9 |

The resulting product was further characterized by size exclusion chromatography.

TABLE 6
Results obtained by size exclusion chromatography

| | | | | | Area |
|---|---|---|---|---|---|
| | Mn | Mw | D | Area % < 4667 | % > 13280 |
| Sample | [g/mol] | [g/mol] | [Mn/Mw] | g/mol | g/mol |
| Starting | 7760 | 8410 | 1.08 | 5.0 | 1.3 |
| material | | | | | |
| Example | 8210 | 8610 | 1.05 | 1.3 | 1.5 |
| #2 | | | | | |

TABLE 7
Results of acid treatment

| | Formaldehyde | Acetaldehyde | Propionic aldehyde |
|---|---|---|---|
| Sample | [ppm] | [ppm] | [ppm] |
| Starting material | <10 | 163 | 257 |
| Example #2 | <10 | 6 | <1 |

The results according to Table 7 show that total aldehyde level in the purified product was below 20 ppm

### Example 3

The third experiment was performed using a 100 mm long 10/6 UF10kDZ membrane (atech innovations gmbh). The circulation vessel B1 was filled with 3275 gram Poloxamer 188 solution, having a solids content of 9.89%. Prior to starting the filtration, the Poloxamer was recycled in the setup under permeate recycle into the feed vessel at 60° C. The pH was set to 3 using 1.84 g 10% H2SO4. The mixture was recirculated for 1 h 20 m. Dosing of the acid did not result in a change in solid contents. Subsequently, the mixture was diafiltrated at 60° C., a cross-flow velocity of 4 m/s and a trans-membrane pressure of 0.1 MPa until a diafiltration factor of 2.79 was reached. Table 8 summarizes the results of this experiment. During this step, the solid contents dropped from 9.96% to 4.30%. Because of the decreased polymer content in the retentate, an increase in the membrane flux was recorded. The retention using this membrane was significantly lower than that in Example 1 and 2.

TABLE 8

| DF | Flux | C_{Ret} | C_{Perm} | R |
|---|---|---|---|---|
| — | kg/m²/h | % | % | — |
| 0.00 | 28.1 | 9.96 | 2.62 | 73.7 |
| 1.00 | 46.7 | 6.95 | 1.66 | 76.1 |
| 1.87 | 70.8 | 4.89 | 1.12 | 77.1 |
| 2.79 | 78.4 | 4.30 | 0.97 | 77.4 |

TABLE 9
Results obtained by size exclusion chromatography

| | | | | | Area |
|---|---|---|---|---|---|
| | Mn | Mw | D | Area % < 4667 | % > 13280 |
| Sample | [g/mol] | [g/mol] | [Mn/Mw] | g/mol | g/mol |
| Starting | 7760 | 8410 | 1.08 | 5.0 | 1.3 |
| material | | | | | |
| Example | 8260 | 8750 | 1.06 | 1.8 | 1.3 |
| #3 | | | | | |

TABLE 10
Results of acid treatment

| | Formaldehyde | Acetaldehyde | Propionic aldehyde |
|---|---|---|---|
| Sample | [ppm] | [ppm] | [ppm] |
| Starting material | <10 | 163 | 257 |
| Example #3 | <10 | 4 | <1 |

The results according to Table 10 show that total aldehyde levels in the purified product were below 20 ppm.

### Example 4

This example was performed using a 100 mm long mono-channel Type 1/6 UF5kD Z membrane (atech innovations gmbh). The circulation vessel B1 was filled with 4003 gram Poloxamer 188 solution, having a solids content of 10.37%. The Polaxomer solution was set to a pH of 3 before filling it into the setup. The mixture was diafiltrated at 60° C., a cross-flow velocity of 4 m/s and a trans-membrane pressure of 0.1 MPa until a diafiltration factor of 3.82 was reached. The fluxes and rejections were within the experimental error comparable to those obtained in Example 2. During the diafiltration step, the solid contents dropped from 10.37% to 4.86%. Because of the decreased polymer content in the retentate, an increase in the membrane flux was recorded.

| | | | | | Area |
|---|---|---|---|---|---|
| | Mn | Mw | D | Area % < 4936 | % > 11612 |
| Sample | [g/mol] | [g/mol] | [Mn/Mw] | g/mol | g/mol |
| Starting | 7330 | 7770 | 1.06 | 4.9 | 1.9 |
| material | | | | | |
| Example | 7790 | 8050 | 1.03 | 1.2 | 1.8 |
| #4 | | | | | |

| | Formaldehyde | Acetaldehyde | Propionic aldehyde |
|---|---|---|---|
| Sample | [ppm] | [ppm] | [pppm] |
| Starting material | <10 | 150 | 234 |
| Example #4 | <10 | <1 | 6 |

The results show that total aldehyde levels in the purified product were below 20 ppm

1. A process for providing purified polyether block copolymers comprising polyoxyethylene (PEO) and polyoxypropylene (PPO) moieties wherein the purified polyether block copolymer is obtained by an ultrafiltration step of a solution of the polyether block copolymer.

2. The process according to claim 1, wherein the polyether block copolymers comprising polyoxyethylene and polyoxypropylene moieties are selected from the group consisting of polyethylene oxide-block-polypropylene oxide copolymers and polyethylene oxide-polypropylene oxide random copolymers.

3. The process according to claim 1, wherein the polyether block copolymers comprising polyoxyethylene and polyoxypropylene moieties are triblock (PEO-PPO-PEO)-copolymers

4. The process according to claim 1 wherein the triblock (PEO-PPO-PEO)-copolymers are poloxamer 188 or poloxamer 407.

5. The process according to claim 1, wherein the solution of the polyether block copolymers treated by ultrafiltration is an aqueous solution or an organic solution or an aqueous-organic solvent mixture.

6. The process according to claim 1, wherein the solution of the polyether block copolymers treated by ultrafiltration is an aqueous solution.

7. The process according to claim 1, wherein a concentration of the polymer in the solution is 2-20% b.w.

8. The process according to claim 1, wherein a concentration of the polymer in the solution is 5-15% b.w.

9. The process according to claim 1, wherein the ultrafiltration is carried out using a membrane separating layer which is a ceramic or polymer or carbon material.

10. The process according to claim 1, wherein the ultrafiltration is carried out using a membrane separating layer with a cut-off in the range of from 1 to 50 kD (kiloDalton).

11. The process according to claim 1, wherein the ultrafiltration step is combined with an acid treatment step, wherein the acid treatment step is carried out prior to or simultaneously with the ultrafiltration step.

12. The process according to claim 11, wherein the acid treatment step is carried out in a solution of the polyether block copolymer in water or an organic solvent or aqueous-organic solvent mixtures

13. The process according to claim 11, wherein the acid treatment is carried out at a pH in the range of from pH 1 to pH 5

14. The process according to claim 11, wherein the acid is selected from the group of inorganic acids consisting of sulfuric acid, nitric acid, hydrochloric acid, sulfonic acid, and phosphoric acid,

15. The process according to claim 11, wherein the acid is hydrochloric or sulfuric acid.

16. The process according to claim 11, wherein the acid is selected from the group of organic acids consisting of formic acid, acetic acid, propionic acid, fumaric acid, tartaric acid, butyric acid, benzoic acid, succinic acid, oxalic acid, malic acid, lactic acid, adipic acid, and citric acid

17. The process according to claim 11 wherein the acid treatment is carried out at temperatures in the range of from 20 to 60° C.

18. The process according to claim 17, wherein the acid treatment is carried out at temperatures in the range of from 25 to 40° C.

19. The process according to claim 1, wherein the purified polyether block copolymer obtained by the ultrafiltration step is further subjected to sequential multi-column size exclusion chromatography in a simulated moving bed apparatus.

20. The process according to claim 19, wherein a process cycle comprises
(vi) providing a feed mixture comprising the block copolymers dissolved in an eluent in a feed vessel,
(vii) subjecting the feed mixture to a chromatographic separation by introducing the feed mixture into an apparatus comprising a plurality of chromatographic columns sequentially linked together, each column comprising a stationary phase,
(viii) after separation collecting a first eluent portion enriched in the purified target block copolymer and a second eluent portion depleted of the purified target block copolymer,
(ix) collecting the purified block copolymer from the first eluent portion, and
(x) recovery of the depleted eluent and recycling the depleted eluent into the process.
